(19) United States
(12) Patent Application Publication
(10) Pub. No.: US 2024/0411724 A1
(43) Pub. Date: Dec. 12, 2024

(54) SYSTEMS AND METHODS FOR ADVANCED DUPLICATE IMAGE SEARCH AND ANALYSIS

(71) Applicant: State Farm Mutual Automobile Insurance Company, Bloomington, IL (US)

(72) Inventors: Geetha P. Nagarajan, Plano, TX (US); Reuven Birnbaum, Urbana, IL (US); John Fletcher, Dallas, TX (US); Salomon Kabongo, Bloomington, IL (US); Anjela Spreen, Hewitt, TX (US); Jun Wen, Plano, TX (US)

(21) Appl. No.: 18/652,500

(22) Filed: May 1, 2024

Related U.S. Application Data
(60) Provisional application No. 63/507,691, filed on Jun. 12, 2023.

(51) Int. Cl. G06F 16/174; G06F 16/14

(52) U.S. Cl. CPC G06F 16/1748; G06F 16/152

(57) ABSTRACT

A computer system is provided and is programmed to: (1) receive a document; (2) execute a hash function to generate a hash of the document; (3) compare the hash of the document to the plurality of hashes for the plurality of documents; (4) determine if an exact match exists between the hash of the document and the plurality of hashes for the plurality of documents; (5) if an exact match exists, indicate that the received document is a duplicate; and (6) if no exact match exists, the at least one processor is programmed to: (a) perform similarity analysis on the document to compare the document to the plurality of stored documents; (b) determine a similarity measure for the document based on the comparison; (c) compare the similarity measure for the document to a threshold; and (d) indicate that the received document is a potential duplicate based upon the comparison.

### CROSS-REFERENCE TO RELATED APPLICATIONS

This application claims priority to U.S. Provisional Patent Application No. 63/507,691, filed Jun. 12, 2023, entitled “SYSTEMS AND METHODS FOR FEATURE REDUCED IMAGE SEARCH AND ANALYSIS,” the entire contents and disclosures of which are hereby incorporated herein by reference in their entirety.

### FIELD OF THE DISCLOSURE

The present disclosure relates to systems and methods for advanced image search and analysis, and more particularly, to a network-based system and method for detecting duplicate and potential duplicate images using advanced image analysis techniques.

### BACKGROUND

Digital images (e.g., photos and/or videos) are oftentimes captured by cameras and stored on memory. In some cases, those digital images are shared with other systems that may process those images further. In some cases, those images may be checked to see if they are duplicate image(s) and whether they need to be stored in computer memory. In some systems that check for duplicates, when a new image comes in, the system cross checks all pixel values across channels in all of the received images to an entire database of images. This may be extremely computationally expensive. Also, this method may not be sensitive to small adjustments to the images, such as, but not limited to, reversing, different contrast, different brightness, slight movement or cropping, and/or other minor adjustments to the images.

In some cases, those received images may need to be further evaluated before being shared so that the information included in the images is better understood and/or labeled so that the further processing may happen. Duplicate images slow down the processing of those images and related actions as they require additional evaluation time and processing. Furthermore, evaluation of such images may be a labor-intensive process and may be dependent upon subject matter expertise.

In addition, storing duplicate images may require significant amounts of computer memory, may cause confusion, and may cause issues with later processing of those images.

In addition, duplicate images may have a negative impact on machine learning training. If the same image is in both the training data and the testing data for machine learning model, this may cause accuracy problems with the trained model. The duplicate image may provide an unfair assessment of the model performance.

Thus, the ability to eliminate duplicate images may be quite important in many situations. Accordingly, a more resource efficient system and/or method for duplicate and potential duplicate image analysis systems would be desirable. Conventional techniques may have additional encumbrances, inefficiencies, ineffectiveness, and drawbacks as well.

### BRIEF SUMMARY

The present embodiments may relate to, inter alia, systems and methods for advanced image search and analysis, and more particularly, to a network-based system and method for detecting duplicate and potential duplicate images using advanced image analysis techniques. The systems and methods described herein may provide for analyzing a plurality of images to detect duplicates and potential duplicates. The present systems and methods may further include a plurality of preprocessed images that are stored for improved image comparison purposes as described herein.

In one aspect, a computer system may be provided. The computer system may include one or more local or remote processors, servers, sensors, memory units, transceivers, mobile devices, wearables, smart watches, smart glasses or contacts, augmented reality glasses, virtual reality headsets, mixed or extended reality headsets, voice bots, chat bots, ChatGPT bots, and/or other electronic or electrical components, which may be in wired or wireless communication with one another. For instance, the computer system may include a computing device that may include at least one processor in communication with at least one memory device. The at least one processor may be configured to: (1) store a plurality of hashes for a plurality of documents; (2) receive a document; (3) execute a hash function to generate a hash of the document; (4) compare the hash of the document to the plurality of hashes for the plurality of documents; (5) determine if an exact match exists between the hash of the document and the plurality of hashes for the plurality of documents; (6) if an exact match exists, indicate that the received document is a duplicate; and/or (7) if no exact match exists, the at least one processor may be programmed to: (a) perform similarity analysis on the document to compare the document to the plurality of stored documents; (b) determine a similarity measure for the document based on the comparison; (c) compare the similarity measure for the document to a threshold; and/or (d) indicate that the received document is a potential duplicate based upon the comparison. The computer system may include additional, less, or alternate functionality, including that discussed elsewhere herein.

In another aspect, a computer-implemented method may be provided. The computer-implemented method may be performed by a duplicate and potential duplicate image detection analysis (DNPIDA) computer device including at least one processor in communication with at least one memory device. The method may include: (1) storing a plurality of hashes for a plurality of documents; (2) receiving a document; (3) executing a hash function to generate a hash of the document; (4) comparing the hash of the document to the plurality of hashes for the plurality of documents; (5) determining if an exact match exists between the hash of the document and the plurality of hashes for the plurality of documents; (6) if an exact match exists, indicating that the received document is a duplicate; and/or (7) if no exact match exists, the method may include: (a) performing similarity analysis on the document to compare the document to the plurality of stored documents; (b) determining a similarity measure for the document based on the comparison; (c) comparing the similarity measure for the document to a threshold; and/or (d) indicating that the received document is a potential duplicate based upon the comparison. The computer-implemented method may include additional, less, or alternate actions, including those discussed elsewhere herein.

In another aspect, at least one non-transitory computer-readable media having computer-executable instructions embodied thereon may be provided. When executed by a computing device including at least one processor in communication with at least one memory device, the computer-executable instructions may cause the at least one processor to: (1) store a plurality of hashes for a plurality of documents; (2) receive a document; (3) execute a hash function to generate a hash of the document; (4) compare the hash of the document to the plurality of hashes for the plurality of documents; (5) determine if an exact match exists between the hash of the document and the plurality of hashes for the plurality of documents; (6) if an exact match exists, indicate that the received document is a duplicate; and/or (7) if no exact match exists, the at least one processor may be programmed to: (a) perform similarity analysis on the document to compare the document to the plurality of stored documents; (b) determine a similarity measure for the document based on the comparison; (c) compare the similarity measure for the document to a threshold; and/or (d) indicate that the received document is a potential duplicate based upon the comparison. The computer-executable instructions may direct additional, less, or alternate functionality, including that discussed elsewhere herein.

Advantages will become more apparent to those skilled in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### BRIEF DESCRIPTION OF THE DRAWINGS

The Figures described below depict various aspects of the systems and methods disclosed therein. It should be understood that each Figure depicts an embodiment of a particular aspect of the disclosed systems and methods, and that each of the Figures is intended to accord with a possible embodiment thereof. Further, wherever possible, the following description refers to the reference numerals included in the following Figures, in which features depicted in multiple Figures are designated with consistent reference numerals.

There are shown in the drawings arrangements which are presently discussed, it being understood, however, that the present embodiments are not limited to the precise arrangements and are instrumentalities shown, wherein:

FIG. 1 illustrates a simplified block diagram of an exemplary process for analyzing and categorizing a plurality of images using a duplicate and potential duplicate image detection analysis system, in accordance with at least one embodiment.

FIG. 2 illustrates a block diagram of an exemplary process for duplicate image detection, in accordance with at least one embodiment.

FIG. 3 illustrates an exemplary process for detecting duplicate and potential duplicate images, in accordance with at least one embodiment.

FIG. 4 illustrates an exemplary computer system for performing the processes shown in FIGS. 1, 2, and 3 using the duplicate and potential duplicate image detection analysis system.

FIG. 5 illustrates an exemplary configuration of a user computer device, in accordance with one embodiment of the present disclosure.

FIG. 6 illustrates an exemplary configuration of a server computer device, in accordance with one embodiment of the present disclosure.

FIG. 7 illustrates a process for performing similarity analysis shown in FIG. 1 using the system shown in FIG. 4.

FIG. 8 illustrates an exemplary process for using machine learning to train for performing similarity analysis shown in FIG. 1.

FIG. 9 illustrates a graph of results of a further process for performing feature reduction using the DNPIDA system shown in FIG. 4.

FIG. 10 illustrates an exemplary block diagram of a Twin Neural Network, also known as a Siamese network.

The Figures depict preferred embodiments for purposes of illustration only. One skilled in the art will readily recognize from the following discussion that alternative embodiments of the systems and methods illustrated herein may be employed without departing from the principles of the invention described herein.

### DETAILED DESCRIPTION OF THE DRAWINGS

The present embodiments may relate to, inter alia, systems and methods for advanced image search and analysis, and more particularly, to a network-based system and method for detecting duplicate and potential duplicate images using advanced image analysis techniques. In one exemplary embodiment, the process may be performed by a duplicate and potential duplicate image detection analysis (“DNPIDA”) system and/or a DNPIDA computer device. In the exemplary embodiment, the DNPIDA system may be in communication with one or more client devices, one or more third-party information sources, and/or one or more databases. As described below in further detail, the DNPIDA computer system includes using one or more methodologies to improve the speed and accuracy of image comparisons to detect duplicate and/or potential duplicate images. As used herein, images may include drawings, photographs, sensor images, scans, paintings, sketches, multilayer images, documents, forms, videos and/or any other image type that may be used in accordance with the systems and methods described herein.

In a first potential use case, duplicate images may affect machine learning models that are trained and tested using images, for example, image classification models. If the training data and the testing data include the same image, the machine learning model may be mis-weighted or mis-aligned. For example, if the model is attested with the duplicated image, then it can provide an incorrect assessment of the trained model's performance. Accordingly, it would be useful to efficiently determine if there are any duplicate and/or potential duplicate images in the training and testing sets.

In a second potential use case, it may be helpful to determine if an image being submitted is a duplicate or a potential duplicate. For example, in a web submission embodiment it may be useful to determine if the images being submitted by a user are duplicates and/or potential duplicates of those that have been previously submitted and stored in one or more databases. For example, in an insurance embodiment, an insured may be submitting images of damage to an item and/or vehicle. In some instances, a user may be submitting an image that they previously submitted and/or had been submitted by others. In some cases, this double submitting of an image may be done on accident or without any fraudulent purposes. In other cases, it may be done as part of a fraud scheme. Furthermore, these images may have been slightly modified or altered. For example, a reversed version of the image may be submitted. Other alterations include, but are not limited to, contrast change, brightness change, color saturation, and/or other image alterations. Accordingly, it would be useful to determine if any of the images submitted are duplicates and/or potential duplicates of those in the databases.

In a third potential use case, a user may need to find images with similar content to a first image. For example, a user is creating a brochure and requires other images to fit their needs. The user submits the image, and the system returns multiple similar images. For example, the user submits an image of a kitchen. The system returns multiple images of similar kitchens.

In another example, the similarity image search may be used for determining previous activities performed in similar situations. For example, the user submits an image of damage to a vehicle or building. The search returns images of similar damages and how those damages were repaired and the associated costs. In the insurance embodiment, the user submits one or more claim photos of damage, and the system returns similar claims and how those claims were processed. In these embodiments, the images may have contextual image attached to and/or associated with the stored images and that additional information is retrieved and presented to the user along with the retrieved images.

In the exemplary embodiment, the DNPIDA system receives an image and performs a duplicate image check on the received image. First the DNPIDA system performs a cryptographic hash on the received image. The cryptographic hash receives the image as input and outputs a value based on the input image. The hash function converts data of any size and converts it into a fixed size. For example, SHA-256 is one type of SHA-2 (Secure Hash Algorithm 2), which was created by the National Security Agency. SHA-256 is a cryptographic hash function that outputs a value that is 256 bits long. For each image input into the SHA-256 algorithm, a 256-bit value is generated. Even a minor change to the input, such as changing one pixel of the image, will cause the hash function to output a different value. One having skill in the art would understand that there are multiple other hash functions that may be used. Many of these hash functions also have outputs of different sizes.

Then the DNPIDA system compares the output hash value to a database of stored hash values for a plurality of other images. If the hash value for the received image is identical to the hash value for a stored image, then the received image is considered a duplicate of the image in the database. In at least one embodiment, the DNPIDA system provides the received image and the identified stored image to a user to confirm that the images are duplicates. However, cryptographic hash functions have low collision chances, so the probabilities of two different images causing the hash function to output the same output value are extremely low. This probability may be reduced by using a hash function with a longer output value.

In the exemplary embodiment, the DNPIDA system may also analyze documents to determine if the documents are duplicates. For documents, such as PDFs and Word Processing documents, the DNPIDA system ignores the metadata from the received document. Then the DNPIDA system divides the document by page. The DNPIDA system converts each page into an image and then performs the hash function on the page of that image. Then each page is compared against the database. If all of the pages of the received document match all of the pages of a document in the database, the received document is a duplicate. In some embodiments, the DNPIDA system indicates which pages are duplicates if not all of the pages in the document are duplicates.

In some embodiments, the DNPIDA system may further receives a plurality of images of a document, such as where a user scanned or photographed the document and provided the images. In these embodiments, the DNPIDA system hashes each of the received images and compares them against the database of hashed documents. If all of the pages match a document, then the received images are of a duplicate document.

In some embodiments, the DNPIDA system informs a user of the duplicate nature of the image or document or portion of the document. The user is given the option of keeping the image or document or discarding the duplicate. In other embodiments, the DNPIDA system determines whether to discard the duplicate image, such as in the training set use case.

If the DNPIDA system does not detect that the document or image has a duplicate in the database(s), then the DNPIDA system analyzes the received document or image for being a potential duplicate. The DNPIDA system analyzes the image or document to determine if there may be a potential duplicate or similar image or document in one or more databases. The DNPIDA system may determine the potential duplicate or similarity of the image or document using one or more different analysis methodologies.

The first methodology is using a perceptual hashing approach to detect potential duplicates. In the perceptual hashing approach, a hash table structure is used to speed up the lookup being processed. The perceptual hashing approach is inspired from human perception of images. “Perceptual” hashing algorithms are a subset of Locality-Sensitive Hashing. The perceptual hashing allows for similar contents to be mapped to a same or nearby hash value. The perceptual hashing approach limits “collisions,” where two images can map to the same hash value. The perceptual hashing approach also uses the similarity/distance between two hash values to have meaning to show similarity between images.

In one embodiment of the perceptual hashing approach, the image is converted to greyscale and resized. In at least one embodiment, the image is resized to an 8×8 pixel image. The DNPIDA system determines the average pixel value for the resized image. For each pixel in the image, if the pixel value is less than the average pixel value, then the DNPIDA system sets the pixel value to 0. Otherwise, the DNPIDA system sets the pixel value to 1. Then the DNPIDA system uses the pixel map to flatten out the image into a hash value. In the 8×8 pixel embodiment, the hash value is 64 bits.

At least one advantage of the perceptual hashing approach is that it may be used to recognize limited augmentation. The hashing value will be largely invariant if the image is resized. The hashing value will be unchanged if image-wide brightness/contrast is slightly adjusted. The DNPIDA system may add seven hash values for every 90-degree rotation and/or mirror transformation. Using the perceptual hashing approach improves the query speed and allows for both retrieving exact results from hash table and retrieving/ranking similar images using some distance/similarity metric. In some embodiments, the DNPIDA system may use the Hamming distance and/or the Jaccard index to determine the distance between and/or similarity between different hash values.

In some embodiments, the DNPIDA system may use other perceptual hashing algorithms. For example, one algorithm is pHash, where after the resizing step, the DNPIDA system uses spectral decomposition to summarize the image. In another algorithm dHash, the DNPIDA system resizes instead to 8×9, and binary transformation is performed by comparing adjacent horizontal pixels.

Another methodology that may be used includes dimension reduction with a feature extractor. The dimension reduction with feature extraction is performed by using machine learning (ML) feature extraction. The purpose of ML feature extraction is to condense the image to a relatively small number of low and/or high level “features,” known as feature vectors. The DNPIDA system uses one or more algorithms such as a Scale Invariant Feature Transformer that maps out areas of interest (dark/bright spots) that are invariant under scale/rotation/color adjustments. The DNPIDA system uses one or more algorithms such as Pulse Coupled Neural Networks which run spectral analysis to identify shapes and patterns in an image. In at least one embodiment, the classification model is trained the layer before the final prediction for large-scale features.

Once all of the images have gone through feature reduction, the DNPIDA system may perform different image retrieval techniques to balance the query time and to minimize false positives. One technique is to use K-d Trees, where the DNPIDA system forms multidimensional binary trees that are successively split by the next element of the feature vector. Another technique is to use Locality-Sensitive Hashing (LSH), where the hashing methods bin (or classify) similar feature vectors into the same hash values. A further technique of LSH is Random Projection Hashing, where the DNPIDA system uses an approximation of the cosine distance between vectors. The basic idea of this technique is to choose a random hyperplane (defined by a normal unit vector r) at the outset and use the hyperplane to hash input vectors. This technique reduces entire feature space into a set of bits (generally much less than the dimension of the feature space). To ensure similar images are being binned correctly, the technique use a set number of these hash tables. Improvements like Density Sensitive Hashing, Kernel-LSH may be integrated to pick improved projection vectors.

Another methodology that may be used includes using a pretrained feature extractor, for example the DINOv2 foundation models. These models are large models that have been pretrained on 142 million images using self-supervised learning with the goal of producing robust embeddings across different image distributions. These models are trained with specially curated training datasets to maximize the size of the dataset without sacrificing data quality. The use of these models allows for analysis of received images to determine a similarity measure for the received image across the training database. For example, the DNPIDA system may have a similarity threshold. Only images that exceed that threshold may be determined to be potential duplicates of other images. Furthermore, the models may also include and provide classifications of the received images.

Another methodology that may be used includes using a finetuned feature extractor. In one embodiment, a Twin Neural Network, also known as a Siamese network, may be used. The Twin Neural Network is an artificial neural network that uses the same weights while working in tandem on two different input vectors to compute comparable output vectors. Often one of the output vectors is precomputed, thus forming a baseline against which the other output vector is compared. This is similar to comparing fingerprints but can be described more technically as a distance function for locality-sensitive hashing.

In this methodology, the DNPIDA system feeds a pair of inputs into these networks. Each network computes the features of one input. And then the similarity measure of features is computed using their difference or dot product. The network is trained to minimize the distance between samples of the same class and increase the inter-class distance. There are multiple kinds of similarity functions through which the Twin Neural Network can be trained, such as, but not limited to, Contrastive loss, triplet loss, and circle loss.

In the exemplary embodiment, the DNPIDA system processes the received image or document to determine if the received image or document is similar to any other images or documents, using one or more of the above methodologies. If the similarity measure exceeds a threshold, the DNPIDA indicates that a similarity exists and provides information about the similarity to one or more users. The users may then determine whether to keep the received image or document or indicate that the received image or document is effectively a duplicate.

In some embodiments, the classifications of the images may be used for insurance purposes. The images may be provided to an insurer, where the insurer may use the images to determine a pre-incident condition of the property. The insurer may also use the images to determine appliances and/or other features/fixtures of the property that need to be replaced and/or valued.

While the above describes using the systems and processes described herein for analyzing property, one having skill in the art would understand that these systems and methods may also be used for classifying items, such as vehicles, antiques, and/or other objects that need to be analyzed and classified. It should also be understood that these systems and methods may also be used for classifying any items shown or included in a digital image or just for determining duplicate and potential duplicate images in general.

At least one of the technical problems addressed by this system may include: (i) identifying and addressing duplicate images received for analysis and/or storage; (ii) reducing the amount of data storage needed for storing images; (iii) reducing computational delays and resources needed for searching for duplicate or similar images; (iv) inability to validate information included in an image; (v) limited classification options analysis systems; and/or (vi) improved speed and accuracy in comparing and matching images.

A technical effect of the systems and processes described herein may be achieved by performing at least one of the following steps: (a) store a plurality of hashes for a plurality of documents; (b) receive a document; (c) execute a hash function to generate a hash of the document; (d) compare the hash of the document to the plurality of hashes for the plurality of documents; (e) determine if an exact match exists between the hash of the document and the plurality of hashes for the plurality of documents; (f) if an exact match exists, indicate that the received document is a duplicate; (g) if no exact match exists, the at least one processor may be programmed to: (1) perform similarity analysis on the document to compare the document to the plurality of stored documents; (2) determine a similarity measure for the document based on the comparison; (3) compare the similarity measure for the document to a threshold; (4) indicate that the received document is a potential duplicate based upon the comparison; (h) wherein the hash function is a cryptographic hash function; (i) wherein the hash function is a SHA-2 (Secure Hash Algorithm 2); (j) perform perceptual hashing on the received document; (k) compare the perceptually hashed document to a plurality of perceptually hashed documents to determine one or more similarities; (l) perform dimension reduction and feature extraction on the received document to generate one or more feature vectors for the received document; (m) compare the one or more feature vectors for the received document to a plurality of stored feature vectors for a plurality of documents to determine one or more similarities; (n) analyze the received document using a pretrained feature extractor model; (o) perform similarity analysis on the received document using a twin neural network; (p) perform similarity analysis on the received document using a plurality of techniques; (q) wherein the received document is at least one of an image, a text document, a PDF, and a plurality of images; (r) wherein the received document includes a plurality of pages; (s) divide the document into a plurality of separate pages; (t) convert each separate page of the plurality of pages into an image; (u) execute the hash function on each image for the plurality of pages; (v) compare the plurality of hashes for the plurality of pages to a plurality of hashes for a plurality of multi-page documents to detect an exact match; (w) ignore any metadata in the document prior to executing the hash function; (x) if an exact match exists, delete the received document; (y) present the received document to a user with the indication that the received document is a duplicate; and/or (z) if the indication is that the received document is a potential duplicate, present the received document and a detected similar document to a user.

### Exemplary Process for Analyzing and Classifying Images Using Feature Reduction

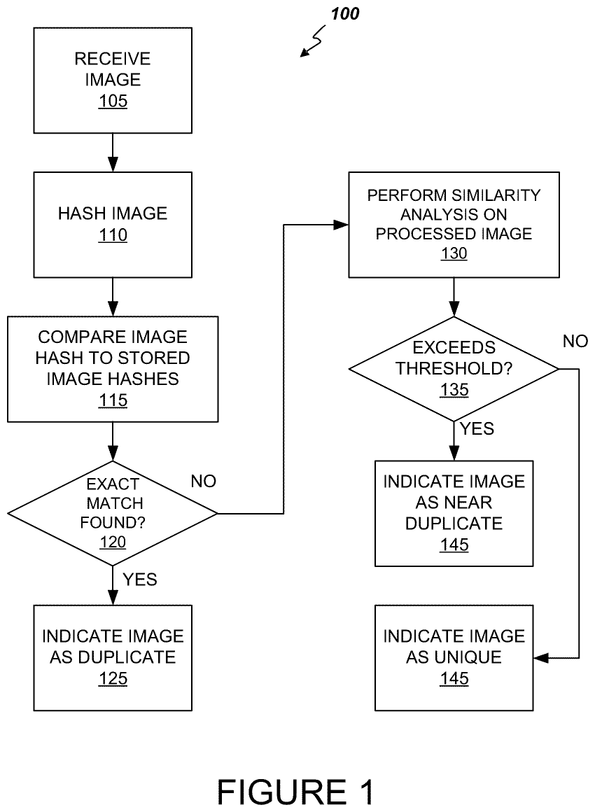

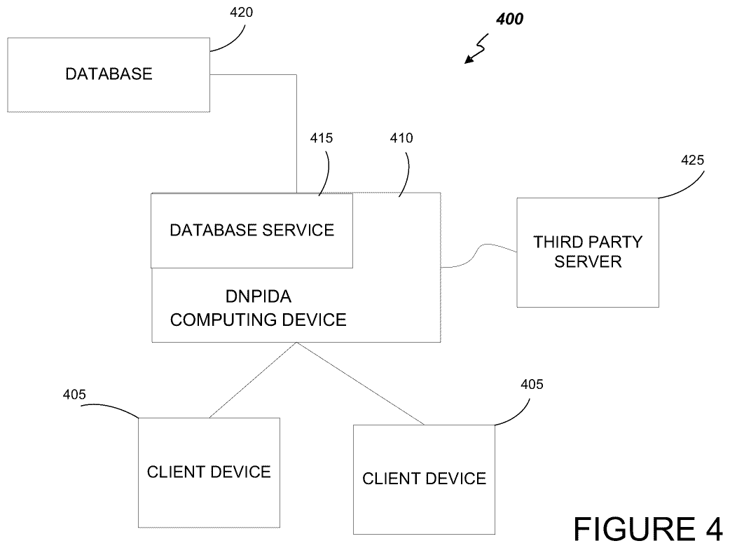

FIG. 1 illustrates a simplified block diagram of an exemplary process 100 for analyzing and categorizing a plurality of images using a duplicate and potential duplicate image detection analysis (“DNPIDA”) system 400 (shown in FIG. 4), in accordance with at least one embodiment.

In the exemplary embodiment, the DNPIDA computing device 410 receives 105 an image. In some embodiments, the image is received from a user via their computer device, such as client device 405 (shown in FIG. 4).

In the exemplary embodiment, the DNPIDA computing device 410 hashes 110 the received image. In the exemplary embodiment, the DNPIDA computing device 410 performs a cryptographic hash on the received image. The cryptographic hash function receives the image as input and outputs a value based on the input image. The hash function converts data of any size and converts it into a fixed size. For example, SHA-256 is one type of SHA-2 (Secure Hash Algorithm 2), which was created by the National Security Agency. SHA-256 is a cryptographic hash function that outputs a value that is 256 bits long. For each image input into the SHA-256 algorithm, a 256-bit value is generated. Even a minor change to the input, such as changing one pixel of the image, will cause the hash function to output a different value. One having skill in the art would understand that there are multiple other hash functions that may be used. Many of these hash functions also have outputs of different sizes.

In the exemplary embodiment, the DNPIDA computing device 410 compares 115 the hash of the received image to a plurality of stored hashes. In the exemplary embodiment, a plurality of stored hashes for a plurality of images are stored in one or more databases, such as database 420 (shown in FIG. 4). The DNPIDA computing device 410 compares 115 the hash of the received image to the stored hashes to detect an exact match 120. Cryptographic hash functions have low collision chances, so the probabilities of two different images causing the hash function to output the same output value are extremely low. This probability may be reduced by using a hash function with a longer output value.

If the hash value for the received image is an exact match 120 to the hash value for a stored image, then the received image is considered a duplicate of the image in the database 420. In the exemplary embodiment, the DNPIDA computing device 410 indicates 125 the received image as a duplicate. In at least one embodiment, the DNPIDA computing device 410 provides the received image and the identified stored image to a user to confirm that the images are duplicates. The user is given the option of keeping the image or document or discarding the duplicate. In other embodiments, the DNPIDA computing device 410 determines whether to discard the duplicate image, such as in the training set use case.

If the DNPIDA computing device 410 does not detect an exact match 120, the DNPIDA computing device 410 analyzes the image to determine if the image has a potential duplicate in the database(s) 420. The DNPIDA computing device 410 performs 130 similarity analysis on the received image. In the exemplary embodiment, the similarity analysis outputs a similarity measure.

The DNPIDA computing device 410 determines if the similarity measure exceeds a threshold 135, such as 80%, for example. The threshold may be set by the user. The threshold may vary based upon the use case, the type of image, and/or any other factors that the user and/or system desires.

If the threshold is exceeded 135, the DNPIDA computing device 410 indicates 140 the image as a potential duplicate. The DNPIDA computing device 410 may then provide the received image and the similar stored image to one or more users, such as view client devices 405. In some embodiments, there may be multiple thresholds and the DNPIDA computing device 410 takes different actions based upon the threshold exceeded. For example, if a 99% threshold is exceeded, then the DNPIDA computing device 410 may considered the received image to be a duplicate image.

If the threshold is not exceeded 135, the DNPIDA computing device 410 indicates that the image is unique or that no similar images have been found in the database 420.

In the exemplary embodiment, the DNPIDA computing device 410 may use one or more one or more different analysis methodologies to perform 130 the similarity analysis. In some embodiments, the DNPIDA computing device 410 performs multiple methodologies and combines the results to determine a final similarity. Furthermore, there may be different similarity thresholds for different methodologies.

The first methodology is using a perceptual hashing approach to detect potential duplicates. In the perceptual hashing approach, a hash table structure is used to speed up the lookup being processed. The perceptual hashing approach is inspired from human perception of images. “Perceptual” hashing algorithms are a subset of Locality-Sensitive Hashing. The perceptual hashing allows for similar contents to be mapped to a same or nearby hash value. The perceptual hashing approach limits “collisions,” where two images can map to the same hash value. The perceptual hashing approach also uses the similarity/distance between two hash values to have meaning to show similarity between images.

In one embodiment of the perceptual hashing approach, the image is converted to greyscale and resized. In at least one embodiment, the image is resized to an 8×8 pixel image. The DNPIDA computing device 410 determines the average pixel value for the resized image. For each pixel in the image, if the pixel value is less than the average pixel value, then the DNPIDA computing device 410 sets the pixel value to 0. Otherwise, the DNPIDA computing device 410 sets the pixel value to 1. Then the DNPIDA computing device 410 uses the pixel map to flatten out the image into a hash value. In the 8×8 pixel embodiment, the hash value is 64 bits.

At least one advantage of the perceptual hashing approach is that it may be used to recognize limited augmentation. The hashing value will be largely invariant if the image is resized. The hashing value will be unchanged if image-wide brightness/contrast is slightly adjusted. The DNPIDA computing device 410 may add seven hash values for every 90-degree rotation and/or mirror transformation. Using the perceptual hashing approach improves the query speed and allows for both retrieving exact results from hash table and retrieving/ranking similar images using some distance/similarity metric. In some embodiments, the DNPIDA computing device 410 may use the Hamming distance and/or the Jaccard index to determine the distance between and/or similarity between different hash values.

In some embodiments, the DNPIDA computing device 410 may use other perceptual hashing algorithms. For example, one algorithm is pHash, where after the resizing step, the DNPIDA computing device 410 uses spectral decomposition to summarize the image. In another algorithm dHash, the DNPIDA computing device 410 resizes instead to 8×9, and binary transformation is performed by comparing adjacent horizontal pixels.

Another methodology that may be used includes dimension reduction with a feature extractor. The dimension reduction with feature extraction is performed by using machine learning (ML) feature extraction. The purpose of ML feature extraction is to condense the image to a relatively small number of low and/or high level “features,” known as feature vectors. The DNPIDA computing device 410 uses one or more algorithms such as a Scale Invariant Feature Transformer that maps out areas of interest (dark/bright spots) that are invariant under scale/rotation/color adjustments. The DNPIDA computing device 410 uses one or more algorithms such as Pulse Coupled Neural Networks which run spectral analysis to identify shapes and patterns in an image. In at least one embodiment, the classification model is trained the layer before the final prediction for large-scale features.

Once all of the images have gone through feature reduction, the DNPIDA computing device 410 may perform different image retrieval techniques to balance the query time and to minimize false positives. One technique is to use K-d Trees, where the DNPIDA computing device 410 forms multidimensional binary trees that are successively split by the next element of the feature vector. Another technique is to use Locality-Sensitive Hashing (LSH), where the hashing methods bin (or classify) similar feature vectors into the same hash values. A further technique of LSH is Random Projection Hashing, where the DNPIDA computing device 410 uses an approximation of the cosine distance between vectors. The basic idea of this technique is to choose a random hyperplane (defined by a normal unit vector r) at the outset and use the hyperplane to hash input vectors. This technique reduces entire feature space into a set of bits (generally much less than the dimension of the feature space). To ensure similar images are being binned correctly, the technique use a set number of these hash tables. Improvements like Density Sensitive Hashing, Kernel-LSH may be integrated to pick improved projection vectors.

Another methodology that may be used includes using a pretrained feature extractor, for example the DINOv2 foundation models. These models are large models that have been pretrained one 142 million images using self-supervised learning with the goal of producing robust embeddings across different image distributions. These models are trained with specially curated training datasets to maximize the size of the dataset without sacrificing data quality. The use of these models allows for analysis of received images to determine a similarity measure for the received image across the training database. For example, the DNPIDA computing device 410 may have a similarity threshold. Only images that exceed that threshold may be determined to be potential duplicates of other images. Furthermore, the models may also include and provide classifications of the received images.

Another methodology that may be used includes using a finetuned feature extractor. In one embodiment, a Twin Neural Network, also known as a Siamese network, may be used. The Twin Neural Network is an artificial neural network that uses the same weights while working in tandem on two different input vectors to compute comparable output vectors. Often one of the output vectors is precomputed, thus forming a baseline against which the other output vector is compared. This is similar to comparing fingerprints but can be described more technically as a distance function for locality-sensitive hashing.

In this methodology, the DNPIDA computing device 410 feeds a pair of inputs into these networks. Each network computes the features of one input. And then the similarity measure of features is computed using their difference or dot product. The network is trained to minimize the distance between samples of the same class and increase the inter-class distance. There are multiple kinds of similarity functions through which the Twin Neural Network can be trained, such as, but not limited to, Contrastive loss, triplet loss, and circle loss.

In the exemplary embodiment, the DNPIDA computing device 410 processes the received image or document to determine if the received image or document is similar to any other images or documents, using one or more of the above methodologies. If the similarity measure exceeds a threshold, the DNPIDA computing device 410 indicates that a similarity exists and provides information about the similarity to one or more users. The users may then determine whether to keep the received image or document or indicate that the received image or document is effectively a duplicate.

In some embodiments, the classifications of the images may be used for insurance purposes. The images may be provided to an insurer, where the insurer may use the images to determine a pre-incident condition of the property. The insurer may also use the images to determine appliances and/or other features/fixtures of the property that need to be replaced and/or valued.

### Exemplary Process for Duplicate Image Detection

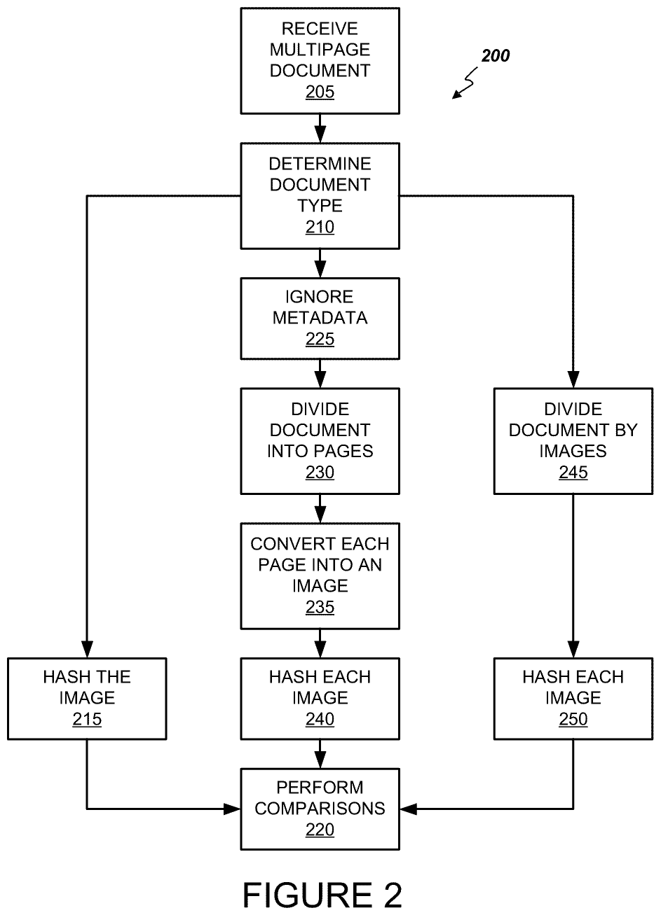

FIG. 2 illustrates a block diagram of an exemplary process 200 for duplicate image detection, in accordance with at least one embodiment. In the exemplary embodiment, the steps of process 200 performed by the DNPIDA computing device 410 (shown in FIG. 4).

In the exemplary embodiment, the DNPIDA computing device 410 receives 205 a document. The document may be an image, a multipage document with text, or a document made up of a plurality of images. The DNPIDA computing device 4100 determines 210 the document type. If the document is a single image, then the DNPIDA computing device 410 hashes 215 and performs comparisons of the hash of the received image to hashes of images in one or more databases, such as database 420 (shown in FIG. 4).

If the document is a multipage document with text, such as PDFs and Word Processing documents, the DNPIDA computing device 410 ignores 225 any metadata from the document. Then the DNPIDA computing device 410 divides 230 the document into individual pages. The DNPIDA computing device 410 converts 235 each page into an image. Then the DNPIDA computing device 410 hashes 240 each of the images. The DNPIDA computing device 410 performs 220 comparisons on the hashes of the images of the pages to those of other documents in the database 420. If all of the pages of the received document match all of the pages of a document in the database, the received document is a duplicate. In some embodiments, the DNPIDA computing device 410 indicates which pages are duplicates if not all of the pages in the document are duplicates.

If the document is a multipage document of images, such as a plurality of images of a document where a user scanned or photographed the document and provided the images, the DNPIDA computing device 410 divides 245 the document by page or image. Then the DNPIDA computing device 410 hashes 250 each of the received images and compares 220 them against the database of hashed documents. If all of the pages match a document, then the received images are of a duplicate document.

In some embodiments, the DNPIDA computing device 410 informs a user of the duplicate nature of the image or document or portion of the document. The user is given the option of keeping the image or document or discarding the duplicate. In other embodiments, the DNPIDA computing device 410 determines whether to discard the duplicate image, such as in the training set use case.

### Exemplary Process for Detecting Duplicate and Potential Duplicate Images

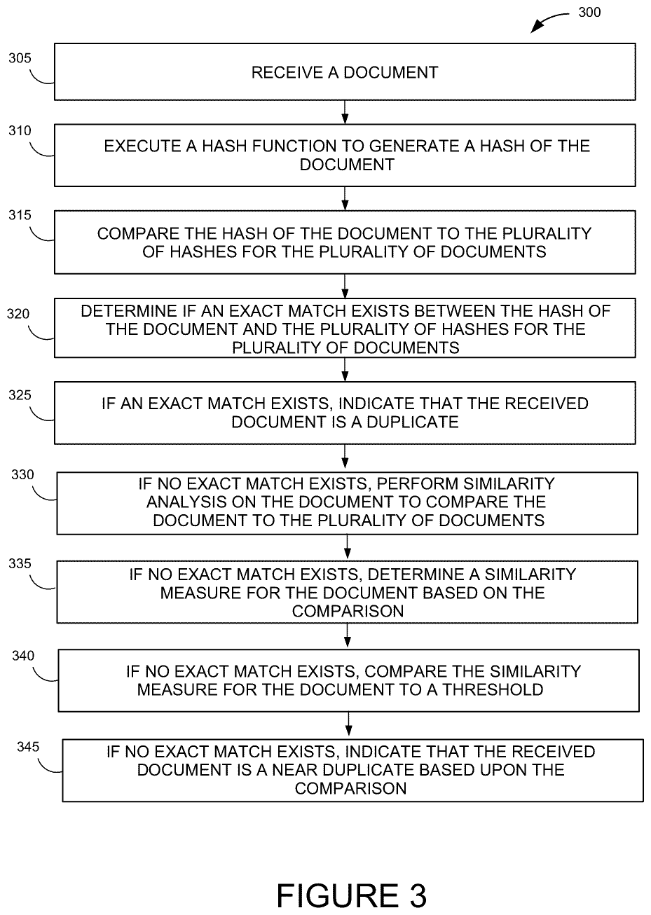

FIG. 3 illustrates an exemplary process 300 for detecting duplicate and potential duplicate images, in accordance with at least one embodiment. In the exemplary embodiment, process 300 is performed by DNPIDA server 410 (shown in FIG. 4).

In the exemplary embodiment, the DNPIDA server 410 stores a plurality of hashes for a plurality of documents, where the documents have been hashed using a cryptographic function, such as, but not limited to, SHA-2 (Secure Hash Algorithm 2). In the exemplary embodiment, the plurality of hashes for the plurality of documents are stored in one or more databases 420. In some further embodiments, each of the plurality of hashes is linked to the corresponding document in the same database 420 or a different database 420.

In the exemplary embodiment, the DNPIDA server 410 receives 305 a document. The received document may include at least one of an image, a text document, a PDF, and a plurality of images.

In the exemplary embodiment, the DNPIDA server 410 execute 310 a hash function to generate a hash of the document. The hash function is a cryptographic function, such as, but not limited to, SHA-2.

In the exemplary embodiment, the DNPIDA server 410 compares 315 the hash of the document to the plurality of hashes for the plurality of documents.

In the exemplary embodiment, the DNPIDA server 410 determines 320 if an exact match exists between the hash of the document and the plurality of hashes for the plurality of documents.

If an exact match exists, the DNPIDA server 410 indicates 325 that the received document is a duplicate.

If no exact match exists, the DNPIDA server 410 performs 330 similarity analysis 130 (shown in FIG. 1) on the document to compare the document to the plurality of documents. The similarity analysis 130 includes methodologies including, but not limited to, perceptual hashing, dimension reduction and feature extraction, using a pretrained feature extractor model, and/or a twin neural network. The similarity analysis 130 may include a plurality of methodologies. In some embodiments, perceptual hashing includes performing perceptual hashing on the received document and comparing the perceptually hashed document to a plurality of perceptually hashed documents to determine one or more similarities. In some embodiments, dimension reduction and feature extraction includes performing dimension reduction and feature extraction on the received document to generate one or more feature vectors for the received document. Then dimension reduction and feature extraction further includes comparing the one or more feature vectors for the received document to a plurality of stored feature vectors for a plurality of documents to determine one or more similarities.

If no exact match exists, the DNPIDA server 410 determines 335 a similarity measure for the document based on the comparison. If no exact match exists, the DNPIDA server 410 compares 340 the similarity measure for the document to a threshold. If no exact match exists, the DNPIDA server 410 indicates that the received document is a potential duplicate based upon the comparison. If the similarity measure for the document exceeds the threshold, then the DNPIDA server 410 indicates that the received document is a potential duplicate.

In some embodiments, if an exact match exists, the DNPIDA server 410 deletes the received document. In other embodiments, if an exact match exists, the DNPIDA server 410 presents the received document to a user with the indication that the received document is a duplicate, such as via a client device 405 (shown in FIG. 4).

In further embodiments, 15. if the indication is that the received document is a potential duplicate, the DNPIDA server 410 presents the received document and a detected similar document to a user, such as via a client device 405.

In still further embodiments, the received document includes a plurality of pages. In these embodiments, the DNPIDA server 410 divides the document into a plurality of separate pages. The DNPIDA server 410 converts each separate page of the plurality of pages into an image. The DNPIDA server 410 executes the hash function on each image for the plurality of pages. The DNPIDA server 410 compares the plurality of hashes for the plurality of pages to a plurality of hashes for a plurality of multi-page documents to detect an exact match. The DNPIDA server 410 may also ignore any metadata in the document prior to executing the hash function.

### Exemplary System

FIG. 4 illustrates an exemplary system 400 for performing the processes 100, 200, and 300 (shown in FIGS. 1, 2, and 3) using the duplicate and potential duplicate image detection analysis (“DNPIDA”) system 400. In the example embodiment, the system 400 is used for comparing images to determine duplication and/or similarities. In some embodiments, the system 400 is also used to analyze the images of property to determine features of that property. In addition, the system 400 is a duplicate and potential duplicate image detection analysis (“DNPIDA”) computer system 410, also known as a DNPIDA server 410 configured to compare images.

As described below in more detail, the DNPIDA server 410 is programmed to analyze images for comparison to other images to determine if the images are duplicates or potential duplicates. In some embodiments, the DNPIDA server 410 is programmed to (1) store a plurality of hashes for a plurality of documents; (2) receive a document; (3) execute a hash function to generate a hash of the document; (4) compare the hash of the document to the plurality of hashes for the plurality of documents; (5) determine if an exact match exists between the hash of the document and the plurality of hashes for the plurality of documents; (6) if an exact match exists, indicate that the received document is a duplicate; and/or (7) if no exact match exists, the at least one processor may be programmed to: (a) perform similarity analysis on the document to compare the document to the plurality of stored documents; (b) determine a similarity measure for the document based on the comparison; (c) compare the similarity measure for the document to a threshold; and/or (d) indicate that the received document is a potential duplicate based upon the comparison.

In the example embodiment, client devices 405 are computers that include a web browser or a software application, which enables client devices 405 to communicate with DNPIDA server 410 using the Internet, a local area network (LAN), or a wide area network (WAN). In some embodiments, the client devices 405 are communicatively coupled to the Internet through many interfaces including, but not limited to, at least one of a network, such as the Internet, a LAN, a WAN, or an integrated services digital network (ISDN), a dial-up-connection, a digital subscriber line (DSL), a cellular phone connection, a satellite connection, and a cable modem. Client devices 405 can be any device capable of accessing a network, such as the Internet, including, but not limited to, a desktop computer, a laptop computer, a personal digital assistant (PDA), a cellular phone, a smartphone, a tablet, a phablet, wearable electronics, smart watch, virtual headsets or glasses (e.g., AR (augmented reality), VR (virtual reality), MR (mixed reality), or XR (extended reality) headsets or glasses), chat bots, voice bots, ChatGPT bots or ChatGPT-based bots, or other web-based connectable equipment or mobile devices.

In the example embodiment, DNPIDA computer device 410 (also known as DNPIDA server 410) is a computer that include a web browser or a software application, which enables DNPIDA server 410 to communicate with client devices 405 using the Internet, a local area network (LAN), or a wide area network (WAN). In some embodiments, the DNPIDA server 410 is communicatively coupled to the Internet through many interfaces including, but not limited to, at least one of a network, such as the Internet, a LAN, a WAN, or an integrated services digital network (ISDN), a dial-up-connection, a digital subscriber line (DSL), a cellular phone connection, a satellite connection, and a cable modem. DNPIDA server 410 can be any device capable of accessing a network, such as the Internet, including, but not limited to, a desktop computer, a laptop computer, a personal digital assistant (PDA), a cellular phone, a smartphone, a tablet, a phablet, wearable electronics, smart watch, virtual headsets or glasses (e.g., AR (augmented reality), VR (virtual reality), MR (mixed reality), or XR (extended reality) headsets or glasses), chat bots, voice bots, ChatGPT bots or ChatGPT-based bots, or other web-based connectable equipment or mobile devices.

A database server 415 is communicatively coupled to a database 420 that stores data. In one embodiment, the database 420 is a database that includes one or more images and/or hashes of images. In some embodiments, the database 420 is stored remotely from the DNPIDA server 410. In some embodiments, the database 420 is decentralized. In the example embodiment, a person can access the database 420 via the client devices 405 by logging onto DNPIDA server 410.

Third-party servers 425 may be any third-party server that DNPIDA server 410 is in communication with that provides additional functionality and/or information to DNPIDA server 410. For example, third-party server 425 may provide images. In the example embodiment, third-party servers 425 are computers that include a web browser or a software application, which enables third-party servers 425 to communicate with DNPIDA server 410 using the Internet, a local area network (LAN), or a wide area network (WAN). In some embodiments, the third-party servers 425 are communicatively coupled to the Internet through many interfaces including, but not limited to, at least one of a network, such as the Internet, a LAN, a WAN, or an integrated services digital network (ISDN), a dial-up-connection, a digital subscriber line (DSL), a cellular phone connection, a satellite connection, and a cable modem. Third-party servers 425 can be any device capable of accessing a network, such as the Internet, including, but not limited to, a desktop computer, a laptop computer, a personal digital assistant (PDA), a cellular phone, a smartphone, a tablet, a phablet, wearable electronics, smart watch, virtual headsets or glasses (e.g., AR (augmented reality), VR (virtual reality), MR (mixed reality), or XR (extended reality) headsets or glasses), chat bots, voice bots, ChatGPT bots or ChatGPT-based bots, or other web-based connectable equipment or mobile devices.

### Exemplary Client Device

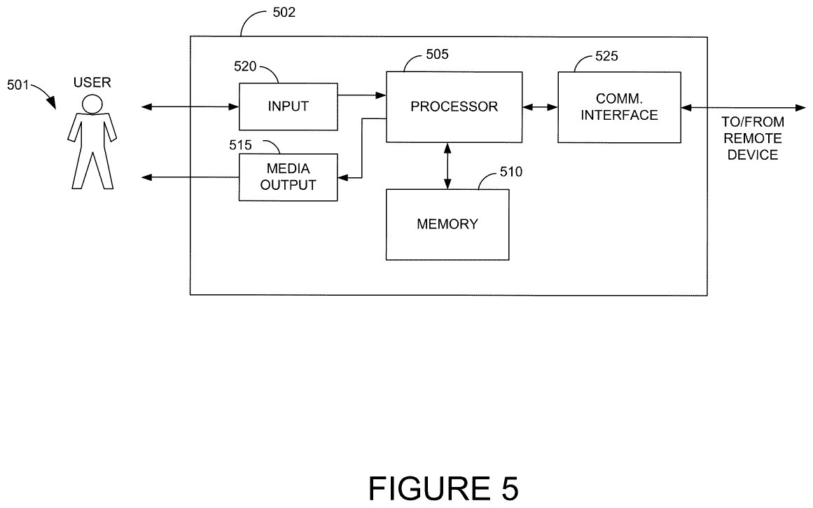

FIG. 5 depicts an exemplary configuration 500 of user computer device 502, in accordance with one embodiment of the present disclosure. In the exemplary embodiment, user computer device 502 may be similar to, or the same as, client device 405 (shown in FIG. 4). User computer device 502 may be operated by a user 501.

User computer device 502 may include a processor 505 for executing instructions. In some embodiments, executable instructions may be stored in a memory area 510. Processor 505 may include one or more processing units (e.g., in a multi-core configuration). Memory area 510 may be any device allowing information such as executable instructions and/or transaction data to be stored and retrieved. Memory area 510 may include one or more computer readable media.

User computer device 502 may also include at least one media output component 515 for presenting information to user 501. Media output component 515 may be any component capable of conveying information to user 501. In some embodiments, media output component 515 may include an output adapter (not shown) such as a video adapter and/or an audio adapter. An output adapter may be operatively coupled to processor 505 and operatively couplable to an output device such as a display device (e.g., a cathode ray tube (CRT), liquid crystal display (LCD), light emitting diode (LED) display, or “electronic ink” display) or an audio output device (e.g., a speaker or headphones).

In some embodiments, media output component 515 may be configured to present a graphical user interface (e.g., a web browser and/or a client application) to user 501. A graphical user interface may include, for example, an interface for viewing items of information provided by the DNPIDA server 410 (shown in FIG. 4). In some embodiments, user computer device 502 may include an input device 520 for receiving input from user 501. User 501 may use input device 520 to, without limitation, provide information either through speech or typing.

Input device 520 may include, for example, a keyboard, a pointing device, a mouse, a stylus, a touch sensitive panel (e.g., a touch pad or a touch screen), a gyroscope, an accelerometer, a position detector, a biometric input device, and/or an audio input device. A single component such as a touch screen may function as both an output device of media output component 515 and input device 520.

User computer device 502 may also include a communication interface 525, communicatively coupled to a remote device such as DNPIDA server 410. Communication interface 525 may include, for example, a wired or wireless network adapter and/or a wireless data transceiver for use with a mobile telecommunications network.

Stored in memory area 510 are, for example, computer readable instructions for providing a user interface to user 501 via media output component 515 and, optionally, receiving and processing input from input device 520. A user interface may include, among other possibilities, a web browser and/or a client application. Web browsers enable users, such as user 501, to display and interact with media and other information typically embedded on a web page or a website from DNPIDA server 410. A client application may allow user 501 to interact with, for example, DNPIDA server 410. For example, instructions may be stored by a cloud service, and the output of the execution of the instructions sent to the media output component 515.

### Exemplary Server Device

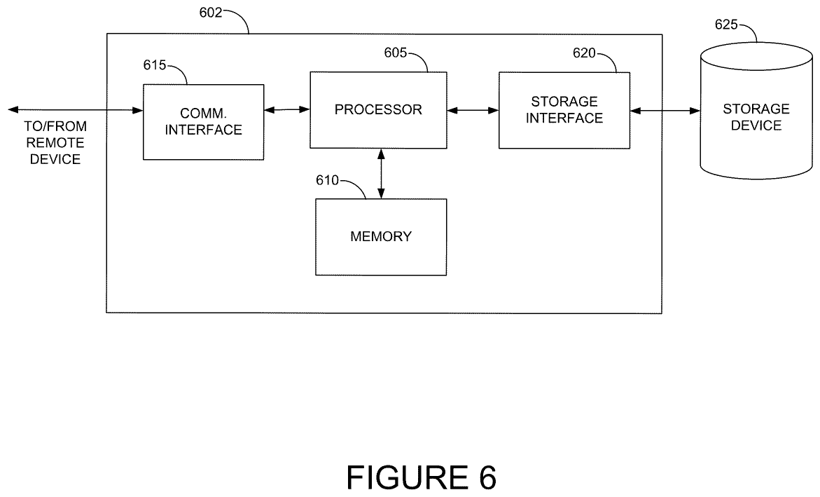

FIG. 6 depicts an exemplary configuration 600 of a server computer device 601, in accordance with one embodiment of the present disclosure. In the exemplary embodiment, server computer device 601 may be similar to, or the same as, DNPIDA computer device 410, database server 415, and third-party server 425 (all shown in FIG. 4). Server computer device 601 may also include a processor 605 for executing instructions. Instructions may be stored in a memory area 610. Processor 605 may include one or more processing units (e.g., in a multi-core configuration).

Processor 605 may be operatively coupled to a communication interface 615 such that server computer device 601 is capable of communicating with a remote device such as another server computer device 601, DNPIDA computer device 410, third-party servers 425, and client devices 405 (shown in FIG. 4) (for example, using wireless communication or data transmission over one or more radio links or digital communication channels). For example, communication interface 615 may audio input from client devices 405 via the Internet, as illustrated in FIG. 4.

Processor 605 may also be operatively coupled to a storage device 634. Storage device 634 may be any computer-operated hardware suitable for storing and/or retrieving data, such as, but not limited to, data associated with one or more models. In some embodiments, storage device 634 may be integrated in server computer device 601. For example, server computer device 601 may include one or more hard disk drives as storage device 634.

In other embodiments, storage device 634 may be external to server computer device 601 and may be accessed by a plurality of server computer devices 601. For example, storage device 634 may include a storage area network (SAN), a network attached storage (NAS) system, and/or multiple storage units such as hard disks and/or solid-state disks in a redundant array of inexpensive disks (RAID) configuration.

In some embodiments, processor 605 may be operatively coupled to storage device 634 via a storage interface 620. Storage interface 620 may be any component capable of providing processor 605 with access to storage device 634. Storage interface 620 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 605 with access to storage device 634.

Processor 605 may execute computer-executable instructions for implementing aspects of the disclosure. In some embodiments, the processor 605 may be transformed into a special purpose microprocessor by executing computer-executable instructions or by otherwise being programmed. For example, the processor 605 may be programmed with the instruction such as illustrated in FIGS. 1, 2, and 3.

### Exemplary Similarity Detection Techniques

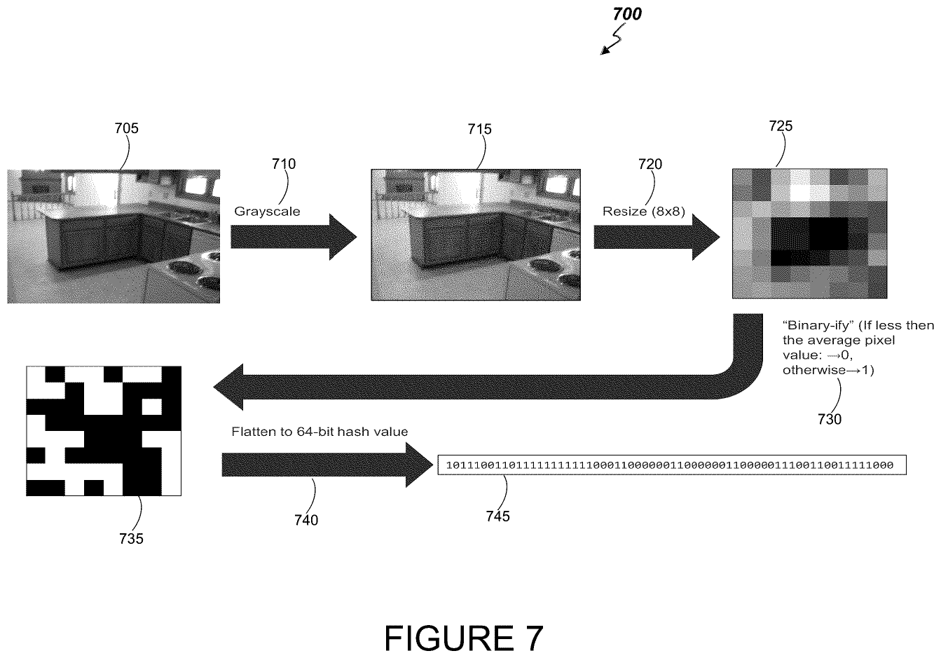

FIGS. 7-10 illustrate various processes 700, 800, and 900, a network 1000 for performing similarity analysis 130 (shown in FIG. 1) using the DNPIDA system 400 (shown in FIG. 4). In the exemplary embodiment, processes 700, 800, and 900 are performed by DNPIDA server 410 (shown in FIG. 4).

In process 700, the similarity analysis 130 is performed by using a perceptual hashing approach. In the perceptual hashing approach, a hash table structure is used to speed up the lookup being processed. The perceptual hashing approach is inspired from human perception of images. “Perceptual” hashing algorithms are a Subset of Locality-Sensitive Hashing. The perceptual hashing allows for similar contents to be mapped to a same or nearby hash value. The perceptual hashing approach limits “collisions,” where two images can map to the same hash value. The perceptual hashing approach also uses the similarity/distance between two hash values to have meaning to show similarity between images.

Process 700 illustrates an exemplary perceptual hashing process. Other methodologies of perceptual hashing may be used in different embodiments and/or in different use cases. In process 700, the DNPIDA server 410 receives an image 705. The DNPIDA server 410 converts 710 the image into a grayscale image 715. Then the DNPIDA server 410 resizes 720 the grayscale image 715. In at least one embodiment, the grayscale image 715 is resized to an 8×8 pixel image 725. The DNPIDA server 410 determines the average pixel value for the resized image 725. For each pixel in the resized image 725, if the pixel value is less than the average pixel value, then the DNPIDA server 410 sets 730 the pixel value to 0. Otherwise, the DNPIDA server 410 sets 730 the pixel value to 1. This allows the DNPIDA server 410 to generate a binary pixel map 735. The DNPIDA server 410 flattens out 740 binary pixel map 735 into a hash value 745. In the 8×8 pixel embodiment, the hash value 745 is 64 bits.

At least one advantage of the perceptual hashing approach is that it may be used to recognize limited augmentation. The hashing value 745 will be largely invariant if the image is resized. The hashing value 745 will be unchanged if image-wide brightness/contrast is slightly adjusted. The DNPIDA server 410 may add seven hash values for every 90-degree rotation and/or mirror transformation. Using the perceptual hashing approach improves the query speed and allows for both retrieving exact results from hash table and retrieving/ranking similar images using some distance/similarity metric. In some embodiments, the DNPIDA server 410 may use the Hamming distance and/or the Jaccard index to determine the distance between and/or similarity between different hash values.

In some embodiments, the DNPIDA server 410 may use other perceptual hashing algorithms. For example, one algorithm is pHash, where after the resizing step, the DNPIDA server 410 uses spectral decomposition to summarize the image. In in another algorithm dHash, the DNPIDA server 410 resizes instead to 8×9, and binary transformation is performed by comparing adjacent horizontal pixels.

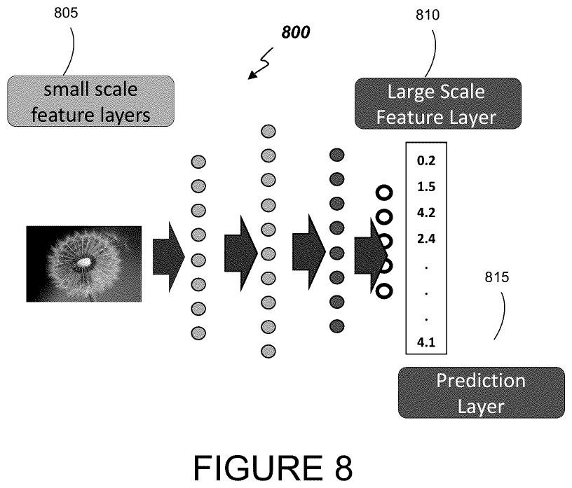

FIG. 8 illustrates an exemplary process 800 for using machine learning to train for performing similarity analysis 130 (shown in FIG. 1). In process 800, the DNPIDA server 410 uses machine learning to train for similarity analysis 130 for small scale feature layers 805 and large-scale feature layers 810. Both small scale feature layers 805 and large-scale feature layers 810 proceed the prediction layer 815.

The similarity analysis 130 is performed by using machine learning (ML) feature extraction. The purpose of ML feature extraction is to condense the image to a relatively small number of low and/or high level “features”, known as feature vectors. The DNPIDA server 410 uses one or more algorithms such as a Scale Invariant Feature Transformer that maps out areas of interest (dark/bright spots) that are invariant under scale/rotation/color adjustments. The DNPIDA server 410 uses one or more algorithms such as Pulse Coupled Neural Networks which run spectral analysis to identify shapes and patterns in an image. In at least one embodiment, the classification model is trained the layer before the final prediction for large-scale features.

Once all of the images have gone through feature reduction, the DNPIDA server 410 may perform different image retrieval techniques to balance the query time and to minimize false positives. One technique is to use K-d Trees, where the DNPIDA server 410 forms multidimensional binary trees that are successively split by the next element of the feature vector. Another technique is to use Locality-Sensitive Hashing (LSH), where the hashing methods bin (or classify) similar feature vectors into the same hash values. A further technique of LSH is Random Projection Hashing, where the DNPIDA server 410 uses an approximation of the cosine distance between vectors. The basic idea of this technique is to choose a random hyperplane (defined by a normal unit vector r) at the outset and use the hyperplane to hash input vectors. This technique reduces entire feature space into a set of bits (generally much less than the dimension of the feature space). To ensure similar images are being binned correctly, the technique use a set number of these hash tables. Improvements like Density Sensitive Hashing, Kernel-LSH may be integrated to pick improved projection vectors.

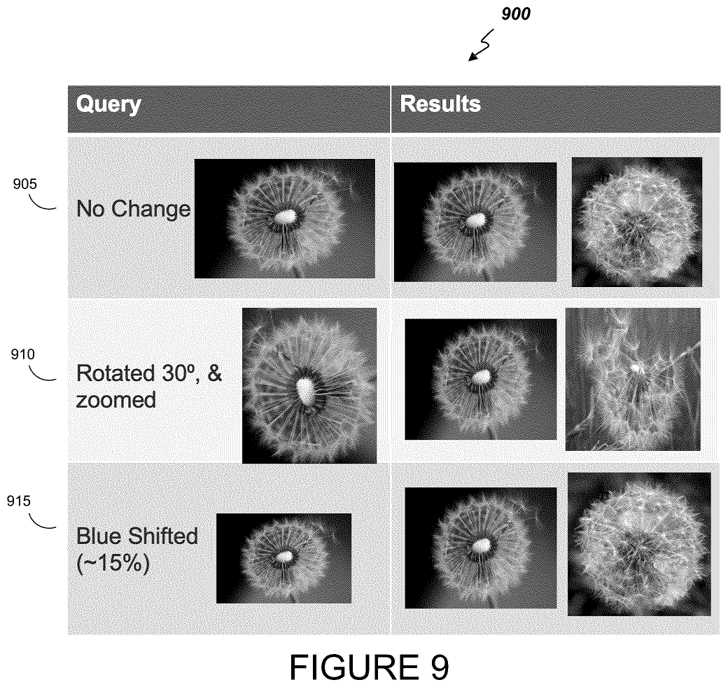

FIG. 9 illustrates a graph of results of a further process 900 for performing feature reduction using the DNPIDA system 400 (shown in FIG. 4).

Another methodology that may be used for similarity analysis 130 includes using a pretrained feature extractor, for example the DINOv2 foundation models. These models are large models that have been pretrained one 142 million images using self-supervised learning with the goal of producing robust embeddings across different image distributions. These models are trained with specially curated training datasets to maximize the size of the dataset without sacrificing data quality. The use of these models allows for analysis of received images to determine a similarity measure for the received image across the training database. For example, the DNPIDA computing device 410 may have a similarity threshold. Only images that exceed that threshold may be determined to be potential duplicates of other images. Furthermore, the models may also include and provide classifications of the received images.

FIG. 9 illustrates three results of a received image being used with the sample image database. The first query 905 has no change in the image and results in one exact match and one similar image. The second query 910 uses the first image but rotated 30 degrees and zoomed in and results in two similar images, including one of the original image. The third query 915 has the original image blue shifted by 15% and results in one exact match to the original image and one similar image.

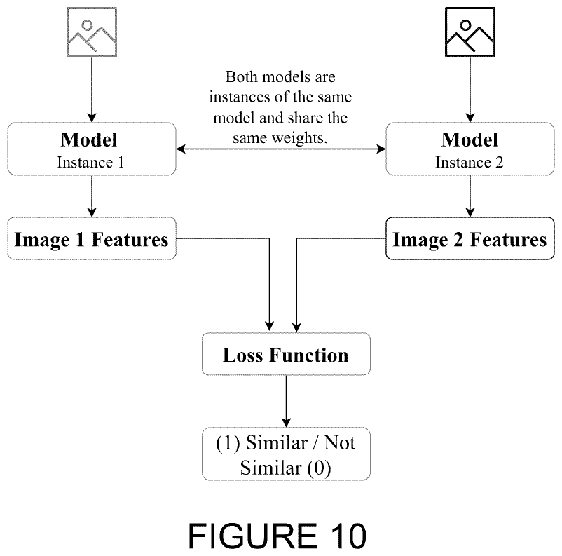

FIG. 10 illustrates an exemplary block diagram of a Twin Neural Network 1000, also known as a Siamese network. In the exemplary embodiment, the Twin Neural Network 1000 may be used for similarity analysis 130 (shown in FIG. 10. The Twin Neural Network 1000 is an artificial neural network that uses the same weights while working in tandem on two different input vectors to compute comparable output vectors. Often one of the output vectors is precomputed, thus forming a baseline against which the other output vector is compared. This is similar to comparing fingerprints but can be described more technically as a distance function for locality-sensitive hashing.

In this methodology, the DNPIDA system 400 (shown in FIG. 4) feeds a pair of inputs 1005 into these networks 1010. Each network 1010 computes the features 1015 of one input 1005. And then the similarity measure of features 1015 is computed using their difference or dot product via a loss function 1020. The network 1000 is trained to minimize the distance between samples of the same class and increase the inter-class distance. There are multiple kinds of similarity functions through which the Twin Neural Network can be trained, such as, but not limited to, Contrastive loss, triplet loss, and circle loss. The network 1000 then outputs a similarity finding 1025, such as a similarity measure.

In some embodiments, the classifications of the images may be used for insurance purposes. The images may be provided to an insurer, where the insurer may use the images to determine a pre-incident condition of the property. The insurer may also use the images to determine appliances and/or other features/fixtures of the property that need to be replaced and/or valued.

### Machine Learning and Other Matters

The computer-implemented methods discussed herein may include additional, less, or alternate actions, including those discussed elsewhere herein. The methods may be implemented via one or more local or remote processors, transceivers, servers, and/or sensors (such as processors, transceivers, servers, and/or sensors mounted on vehicles or mobile devices, or associated with smart infrastructure or remote servers), and/or via computer-executable instructions stored on non-transitory computer-readable media or medium.

In some embodiments, DNPIDA server 410 is configured to implement machine learning, such that DNPIDA server 410 “learns” to analyze, organize, and/or process data without being explicitly programmed. Machine learning may be implemented through machine learning methods and algorithms (“ML methods and algorithms”). In an exemplary embodiment, a machine learning module (“ML module”) is configured to implement ML methods and algorithms. In some embodiments, ML methods and algorithms are applied to data inputs and generate machine learning outputs (“ML outputs”). Data inputs may include but are not limited to images. ML outputs may include, but are not limited to: identified objects, items classifications, and/or other data extracted from the images. In some embodiments, data inputs may include certain ML outputs.

In some embodiments, at least one of a plurality of ML methods and algorithms may be applied, which may include but are not limited to: linear or logistic regression, instance-based algorithms, regularization algorithms, decision trees, Bayesian networks, cluster analysis, association rule learning, artificial neural networks, twin neural network, deep learning, combined learning, reinforced learning, dimensionality reduction, and support vector machines. In various embodiments, the implemented ML methods and algorithms are directed toward at least one of a plurality of categorizations of machine learning, such as supervised learning, unsupervised learning, and reinforcement learning.

In one embodiment, the ML module employs supervised learning, which involves identifying patterns in existing data to make predictions about subsequently received data. Specifically, the ML module is “trained” using training data, which includes example inputs and associated example outputs. Based upon the training data, the ML module may generate a predictive function which maps outputs to inputs and may utilize the predictive function to generate ML outputs based upon data inputs. The example inputs and example outputs of the training data may include any of the data inputs or ML outputs described above. In the exemplary embodiment, a processing element may be trained by providing it with a large sample of images with known characteristics or features. Such information may include, for example, information associated with a plurality of images of a plurality of different objects, items, and/or property.

In another embodiment, a ML module may employ unsupervised learning, which involves finding meaningful relationships in unorganized data. Unlike supervised learning, unsupervised learning does not involve user-initiated training based upon example inputs with associated outputs. Rather, in unsupervised learning, the ML module may organize unlabeled data according to a relationship determined by at least one ML method/algorithm employed by the ML module. Unorganized data may include any combination of data inputs and/or ML outputs as described above.

In yet another embodiment, a ML module may employ reinforcement learning, which involves optimizing outputs based upon feedback from a reward signal. Specifically, the ML module may receive a user-defined reward signal definition, receive a data input, utilize a decision-making model to generate a ML output based upon the data input, receive a reward signal based upon the reward signal definition and the ML output, and alter the decision-making model so as to receive a stronger reward signal for subsequently generated ML outputs. Other types of machine learning may also be employed, including deep or combined learning techniques.

In some embodiments, generative artificial intelligence (AI) models (also referred to as generative machine learning (ML) models) may be utilized with the present embodiments, and may the voice bots or chatbots discussed herein may be configured to utilize artificial intelligence and/or machine learning techniques. For instance, the voice or chatbot may be a ChatGPT chatbot. The voice or chatbot may employ supervised or unsupervised machine learning techniques, which may be followed by and/or used in conjunction with reinforced or reinforcement learning techniques. The voice or chatbot may employ the techniques utilized for ChatGPT. The voice bot, chatbot, ChatGPT-based bot, ChatGPT bot, and/or other bots may generate audible or verbal output, text, or textual output, visual or graphical output, output for use with speakers and/or display screens, and/or other types of output for user and/or other computer or bot consumption.

Based upon these analyses, the processing element may learn how to identify characteristics and patterns that may then be applied to analyzing and classifying objects. The processing element may also learn how to identify attributes of different objects in different lighting. This information may be used to determine which classification models to use and which classifications to provide.

### Exemplary Embodiments

In one aspect, a computer system may be provided. The computer system may include one or more local or remote processors, servers, sensors, memory units, transceivers, mobile devices, wearables, smart watches, smart glasses or contacts, augmented reality glasses, virtual reality headsets, mixed or extended reality headsets, voice bots, chat bots, ChatGPT bots, and/or other electronic or electrical components, which may be in wired or wireless communication with one another. For instance, the computer system may include at least one processor in communication with at least one memory device. The at least one processor may be configured to: (1) store a plurality of hashes for a plurality of documents; (2) receive a document; (3) execute a hash function to generate a hash of the document; (4) compare the hash of the document to the plurality of hashes for the plurality of documents; (5) determine if an exact match exists between the hash of the document and the plurality of hashes for the plurality of documents; (6) if an exact match exists, indicate that the received document is a duplicate; and/or (7) if no exact match exists, the at least one processor may be programmed to: (a) perform similarity analysis on the document to compare the document to the plurality of stored documents; (b) determine a similarity measure for the document based on the comparison; (c) compare the similarity measure for the document to a threshold; and/or (d) indicate that the received document is a potential duplicate based upon the comparison. The system may include additional, less, or alternate functionality, including that discussed elsewhere herein.

An enhancement of the system may include a processor configured to analyze and compare images and documents. The personal information may be, for instance, retrieved from one or more memory units and/or acquired via one or more sensors, including microphones, mobile devices, AR or VR headsets or glasses, smart glasses, wearables, smart watches, or other electronic or electrical devices; and/or acquired via, or at the direction of, generative AI or machine learning models, such as at the direction of bots, such as ChatGPT bots, or other chat or voice bots, interconnected with one or more sensors, including cameras or video recorders.

A further enhancement of the system may include where the hash function is a cryptographic hash function. The system may also include where the hash function is a SHA-2 (Secure Hash Algorithm 2).

A further enhancement of the system may include a processor configured to perform perceptual hashing on the received document. The system may further compare the perceptually hashed document to a plurality of perceptually hashed documents to determine one or more similarities.

A further enhancement of the system may include a processor configured to perform dimension reduction and feature extraction on the received document to generate one or more feature vectors for the received document. The system may further compare the one or more feature vectors for the received document to a plurality of stored feature vectors for a plurality of documents to determine one or more similarities.

A further enhancement of the system may include a processor configured to analyze the received document using a pretrained feature extractor model.

A further enhancement of the system may include a processor configured to perform similarity analysis on the received document using a twin neural network.

A further enhancement of the system may include a processor configured to perform similarity analysis on the received document using a plurality of techniques.

A further enhancement of the system may include where the received document is at least one of an image, a text document, a PDF, and a plurality of images.

A further enhancement of the system may include the received document includes a plurality of pages. The further enhancement of the system may include a processor configured to divide the document into a plurality of separate pages. The system may also include a processor configured to convert each separate page of the plurality of pages into an image. The system may further include a processor configured to execute the hash function on each image for the plurality of pages. In addition, the system may include a processor configured to compare the plurality of hashes for the plurality of pages to a plurality of hashes for a plurality of multi-page documents to detect an exact match. Furthermore, the system may include a processor configured to ignore any metadata in the document prior to executing the hash function. If an exact match exists, a further enhancement of the system may include a processor configured to delete the received document. If an exact match exists, a further enhancement of the system may include a processor configured to present the received document to a user with the indication that the received document is a duplicate.

If the indication is that the received document is a potential duplicate, a further enhancement of the system may include a processor configured to present the received document and a detected similar document to a user.

In another aspect, a computer-implemented method may be provided. The computer-implemented method may be performed by a feature reduction image analysis (FRIA) computer device including at least one processor in communication with at least one memory device. The method may include: (1) storing a plurality of hashes for a plurality of documents; (2) receiving a document; (3) executing a hash function to generate a hash of the document; (4) comparing the hash of the document to the plurality of hashes for the plurality of documents; (5) determining if an exact match exists between the hash of the document and the plurality of hashes for the plurality of documents; (6) if an exact match exists, indicating that the received document is a duplicate; and/or (7) if no exact match exists, the method may include: (a) performing similarity analysis on the document to compare the document to the plurality of stored documents; (b) determining a similarity measure for the document based on the comparison; (c) comparing the similarity measure for the document to a threshold; and/or (d) indicating that the received document is a potential duplicate based upon the comparison. The computer-implemented method may include additional, less, or alternate actions, including those discussed elsewhere herein.

An enhancement of the method may include analyzing and comparing images and documents The privacy interactions may be, for instance, retrieved from one or more memory units and/or acquired via one or more sensors, including cameras, microphones, mobile devices, AR or VR headsets or glasses, smart glasses, wearables, smart watches, or other electronic or electrical devices; and/or acquired via, or at the direction of, generative AI or machine learning models, such as at the direction of bots, such as ChatGPT bots, or other chat or voice bots, interconnected with one or more sensors, including cameras or video recorders.

An enhancement of the computer-implemented method may include where the hash function is a cryptographic hash function based upon the comparison.

An enhancement of the computer-implemented method may include where the received document is at least one of an image, a text document, a PDF, and a plurality of images.

An enhancement of the computer-implemented method may include where the received document includes a plurality of pages. The method may further include dividing document into a plurality of separate pages. The method may also include converting each separate page of the plurality of pages into an image. In addition, the method may include executing the hash function on each image for the plurality of pages. Moreover, the method may include comparing the plurality of hashes for the plurality of pages to a plurality of hashes for a plurality of multi-page documents to detect an exact match.

In another aspect, at least one non-transitory computer-readable media having computer-executable instructions embodied thereon may be provided. When executed by a computing device including at least one processor in communication with at least one memory device, the computer-executable instructions may cause the at least one processor to: (1) store a plurality of hashes for a plurality of documents; (2) receive a document; (3) execute a hash function to generate a hash of the document; (4) compare the hash of the document to the plurality of hashes for the plurality of documents; (5) determine if an exact match exists between the hash of the document and the plurality of hashes for the plurality of documents; (6) if an exact match exists, indicate that the received document is a duplicate; and/or (7) if no exact match exists, the at least one processor may be programmed to: (a) perform similarity analysis on the document to compare the document to the plurality of stored documents; (b) determine a similarity measure for the document based on the comparison; (c) compare the similarity measure for the document to a threshold; and/or (d) indicate that the received document is a potential duplicate based upon the comparison. The computer-executable instructions may direct additional, less, or alternate functionality, including that discussed elsewhere herein.

### ADDITIONAL CONSIDERATIONS

As will be appreciated based upon the foregoing specification, the above-described embodiments of the disclosure may be implemented using computer programming or engineering techniques including computer software, firmware, hardware or any combination or subset thereof. Any such resulting program, having computer-readable code means, may be embodied or provided within one or more computer-readable media, thereby making a computer program product, i.e., an article of manufacture, according to the discussed embodiments of the disclosure. The computer-readable media may be, for example, but is not limited to, a fixed (hard) drive, diskette, optical disk, magnetic tape, semiconductor memory such as read-only memory (ROM), and/or any transmitting/receiving medium such as the Internet or other communication network or link. The article of manufacture containing the computer code may be made and/or used by executing the code directly from one medium, by copying the code from one medium to another medium, or by transmitting the code over a network.

These computer programs (also known as programs, software, software applications, “apps,” or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

As used herein, the term “database” can refer to either a body of data, a relational database management system (RDBMS), or to both. As used herein, a database can include any collection of data including hierarchical databases, relational databases, flat file databases, object-relational databases, object-oriented databases, and any other structured collection of records or data that is stored in a computer system. The above examples are example only, and thus are not intended to limit in any way the definition and/or meaning of the term database. Examples of RDBMS' include, but are not limited to including, Oracle® Database, MySQL, IBM® DB2, Microsoft® SQL Server, Sybase®, and PostgreSQL. However, any database can be used that enables the systems and methods described herein. (Oracle is a registered trademark of Oracle Corporation, Redwood Shores, California; IBM is a registered trademark of International Business Machines Corporation, Armonk, New York; Microsoft is a registered trademark of Microsoft Corporation, Redmond, Washington; and Sybase is a registered trademark of Sybase, Dublin, California.)

As used herein, a processor may include any programmable system including systems using micro-controllers, reduced instruction set circuits (RISC), application specific integrated circuits (ASICs), logic circuits, and any other circuit or processor capable of executing the functions described herein. The above examples are example only, and are thus not intended to limit in any way the definition and/or meaning of the term “processor.”

As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are example only, and are thus not limiting as to the types of memory usable for storage of a computer program.

In another example, a computer program is provided, and the program is embodied on a computer-readable medium. In an example, the system is executed on a single computer system, without requiring a connection to a server computer. In a further example, the system is being run in a Windows® environment (Windows is a registered trademark of Microsoft Corporation, Redmond, Washington). In yet another example, the system is run on a mainframe environment and a UNIX® server environment (UNIX is a registered trademark of X/Open Company Limited located in Reading, Berkshire, United Kingdom). In a further example, the system is run on an iOS® environment (iOS is a registered trademark of Cisco Systems, Inc. located in San Jose, CA). In yet a further example, the system is run on a Mac OS® environment (Mac OS is a registered trademark of Apple Inc. located in Cupertino, CA). In still yet a further example, the system is run on Android® OS (Android is a registered trademark of Google, Inc. of Mountain View, CA). In another example, the system is run on Linux® OS (Linux is a registered trademark of Linus Torvalds of Boston, MA). The application is flexible and designed to run in various different environments without compromising any major functionality.

In some embodiments, the system includes multiple components distributed among a plurality of computing devices. One or more components may be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes.

As used herein, an element or step recited in the singular and proceeded with the word “a” or “an” should be understood as not excluding plural elements or steps, unless such exclusion is explicitly recited. Furthermore, references to “example” or “one example” of the present disclosure are not intended to be interpreted as excluding the existence of additional examples that also incorporate the recited features. Further, to the extent that terms “includes,” “including,” “has,” “contains,” and variants thereof are used herein, such terms are intended to be inclusive in a manner similar to the term “comprises” as an open transition word without precluding any additional or other elements.

Furthermore, as used herein, the term “real-time” refers to at least one of the time of occurrence of the associated events, the time of measurement and collection of predetermined data, the time to process the data, and the time of a system response to the events and the environment. In the examples described herein, these activities and events occur substantially instantaneously.

The patent claims at the end of this document are not intended to be construed under 35 U.S.C. § 112(f) unless traditional means-plus-function language is expressly recited, such as “means for” or “step for” language being expressly recited in the claim(s).

This written description uses examples to disclose the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

We claim:

1. A computer system comprising at least one processor in communication with at least one memory device, wherein the at least one processor programmed to:
store a plurality of hashes for a plurality of documents;
receive a document;
execute a hash function to generate a hash of the document;
compare the hash of the document to the plurality of hashes for the plurality of documents;
determine if an exact match exists between the hash of the document and the plurality of hashes for the plurality of documents;
if an exact match exists, indicate that the received document is a duplicate; and
if no exact match exists, the at least one processor is programmed to:
perform similarity analysis on the document to compare the document to the plurality of documents;
determine a similarity measure for the document based on the comparison;
compare the similarity measure for the document to a threshold; and
indicate that the received document is a potential duplicate based upon the comparison.

2. The computer system of claim 1, wherein the hash function is a cryptographic hash function.

3. The computer system of claim 1, wherein the hash function is a SHA-2 (Secure Hash Algorithm 2).

4. The computer system of claim 1, wherein the at least one processor is further programmed to:
perform perceptual hashing on the received document; and
compare the perceptually hashed document to a plurality of perceptually hashed documents to determine one or more similarities.

5. The computer system of claim 1, wherein the at least one processor is further programmed to perform dimension reduction and feature extraction on the received document to generate one or more feature vectors for the received document.

6. The computer system of claim 5, wherein the at least one processor is further programmed to compare the one or more feature vectors for the received document to a plurality of stored feature vectors for a plurality of documents to determine one or more similarities.

7. The computer system of claim 1, wherein the at least one processor is further programmed to analyze the received document using a pretrained feature extractor model.

8. The computer system of claim 1, wherein the at least one processor is further programmed to perform similarity analysis on the received document using a twin neural network.

9. The computer system of claim 1, wherein the at least one processor is further programmed to perform similarity analysis on the received document using a plurality of techniques.

10. The computer system of claim 1, wherein the received document is at least one of an image, a text document, a PDF, and a plurality of images.

11. The computer system of claim 1, wherein the received document includes a plurality of pages, and wherein the at least one processor is further programmed to:
divide the document into a plurality of separate pages;
convert each separate page of the plurality of pages into an image;
execute the hash function on each image for the plurality of pages; and
compare the plurality of hashes for the plurality of pages to a plurality of hashes for a plurality of multi-page documents to detect an exact match.

12. The computer system of claim 11, wherein the at least one processor is further programmed to ignore any metadata in the document prior to executing the hash function.

13. The computer system of claim 1, wherein if an exact match exists, the at least one processor is further programmed to delete the received document.

14. The computer system of claim 1, wherein if an exact match exists, the at least one processor is further programmed to present the received document to a user with the indication that the received document is a duplicate.

15. The computer system of claim 1, wherein if the indication is that the received document is a potential duplicate, the at least one processor is further programmed to present the received document and a detected similar document to a user.

16. A computer-implemented method to be implemented by computer device including at least one processor in communication with at least one memory device, the method comprises:
storing a plurality of hashes for a plurality of documents;
receiving a document;
executing a hash function to generate a hash of the document;
comparing the hash of the document to the plurality of hashes for the plurality of documents;
determining if an exact match exists between the hash of the document and the plurality of hashes for the plurality of documents;
if an exact match exists, indicating that the received document is a duplicate; and
if no exact match exists, the method comprises:
performing similarity analysis on the document to compare the document to the plurality of documents;
determining a similarity measure for the document based on the comparison;
comparing the similarity measure for the document to a threshold; and
indicating that the received document is a potential duplicate based upon the comparison.

17. The computer-implemented method of claim 16, wherein the hash function is a cryptographic hash function based upon the comparison.

18. The computer-implemented method of claim 16, wherein the received document is at least one of an image, a text document, a PDF, and a plurality of images.

19. The computer-implemented method of claim 16, wherein the received document includes a plurality of pages, and further comprising:
dividing document into a plurality of separate pages;
converting each separate page of the plurality of pages into an image;
executing the hash function on each image for the plurality of pages; and
comparing the plurality of hashes for the plurality of pages to a plurality of hashes for a plurality of multi-page documents to detect an exact match.

20. At least one non-transitory computer-readable media having computer-executable instructions embodied thereon, wherein when executed by a computing device including at least one processor in communication with at least one memory device, the computer-executable instructions cause the at least one processor to:
store a plurality of hashes for a plurality of documents;
receive a document;
execute a hash function to generate a hash of the document;
compare the hash of the document to the plurality of hashes for the plurality of documents;
determine if an exact match exists between the hash of the document and the plurality of hashes for the plurality of documents;
if an exact match exists, indicate that the received document is a duplicate; and
if no exact match exists, the at least one processor is programmed to:
perform similarity analysis on the document to compare the document to the plurality of documents;
determine a similarity measure for the document based on the comparison;
compare the similarity measure for the document to a threshold; and
indicate that the received document is a potential duplicate based upon the comparison.
